(19) United States
(12) Patent Application Publication
(10) Pub. No.: US 2012/0310698 A1
(43) Pub. Date: Dec. 6, 2012

(54) Method and Apparatus for Review and Analysis of Project Schedules

(75) Inventors: Mohamed Y. Hegab, Irvine, CA (US); Ahmed Zahran, Irvine, CA (US); Waleed Bassyoni, Irvine, CA (US); Hany Awad, Irvine, CA (US)

(73) Assignee: EyeDeal Tech, Inc., Irvine, CA (US)

(21) Appl. No.: 13/150,296

(22) Filed: Jun. 1, 2011

(51) Int. Cl. G06Q 10/00

(52) U.S. Cl. 705/7.26

(57) ABSTRACT

A timeline schedule analysis study is modeled for automatically generating business intelligence information regarding the timeline schedule. A software application program is provided that has equations and business rules that together define a process, a timeline, and deliverables associated with the timeline schedule analysis. The program is populated with timeline schedules prepared using other software.

The program provides a process and apparatus for identifying and ranking activities with anomalies in a list based on equations and business rules. In order to evaluate and forecast the performance of the timeline schedule, trend analysis of the anomaly metrics is automatically generated. An apparatus for collaboration between project's parties to enhance the communications and facilitate exchanging the comments and changes of the timeline schedule is provided. Business intelligence information is then automatically generated using the equations and business rules in the program, and the items entered into the program.

### BACKGROUND OF THE INVENTION

In the project management practice, there are multiple parties that are required to create or review a program's or project's schedule or plan, called schedule in this patent. Schedulers are required to submit the project's or program's schedule , called project in here, to the project owners which can be individual, private, public, or a federal entity to get approval of the project's progress and the plan for the remaining portion of it. The schedule submittal is almost always a mandatory requirement of public projects including state and federally funded projects. The schedule is needed for different reasons such as monitoring progress, evaluating change orders and claims, estimating completion dates, estimating completion costs, etc. The interpretation and analysis of the schedule's data is a complex and time consuming because there are many interrelated data items in the schedule. The process for interchanging required actions to reach an approved schedule of the project is also complex and time consuming. A major reason for the complexity involves requiring every party to have an experienced person to analyze and interpret the schedule, consuming a remarkable amount of time and money to validate the findings and respond to actions required to be taken. This process is also problematic since the counter party does not know which activities are the real causes of the issue. Two major processes are performed in order to achieve schedule approval by the owner. The first process is the analysis, interpreting, and identification of the issues. The second process is communicating the findings and reaching the final form of the schedule.

“Deliverables” refer to the findings resulting from the deriving the metrics and performing analysis of the studied schedule. The deliverables include findings provided to the owner's representative, or the entity requesting the schedule, (referred to as owner), to approve or reject the schedule. After performing the analysis by the party requested to create the schedule, (referred to as scheduler), there are various issues in illustrating the findings' relation to the deliverables that are presented. Sometimes a scheduler cannot identify the activity that is the real cause of a certain findings. This might happen because an indirect effect of an issue can cause a finding in another activity. Mistakenly selecting the wrong cause of the finding can create more problems in the schedule. Repeating the process of selecting the wrong source of the finding can cause disruption of the schedule, extra cost of unneeded acceleration of activities, as well as extra cost and time for the schedule review process.

Although the scheduler may carefully document activities and the costs associated with them, it is difficult and time consuming to decide upon the source of the issue. Scheduling is usually done using commercially available software. Errors in entering data, lack of knowledge of the best practices in scheduling, lack of knowledge for sequencing activities, lack of project management skills, or other reasons result in the issues. Identifying the activities that have errors or changes that will not grant owner's approval can be a time consuming and sometimes impossible to be done because of lack of knowledge and expertise.

In order to try to reduce the confusion and errors, some companies have implemented scheduling management systems. However, the scheduling management systems have not been successful beyond the level of identifying scattered issues using basic metric because since these systems lack an integrated combination of business rules, formulas, and knowledge to flag potentially erroneous activities. These systems contain only what has been data-entered into the system. In addition, these scheduling management systems do not tie into the objectives of the owner to track that the changes of activities, budget, or other metrics from one period to the other. They offer at most comparison of two schedule updates. These schedule management systems also lack the capability to take action in a real-time to exchange comments and responses.

### BRIEF SUMMARY OF THE INVENTION

A schedule analysis and review method is modeled by automatically generating business intelligence information. A software application program is provided as apparatus, called apparatus in here, that has equations and business rules that together define a process, and deliverables associated with the schedule analysis and review method.

The program is populated with metrics and analysis results. It includes rules and charts that have been designed to deliver the schedule analysis and review methods, including time, budget, cost items, and amounts related to the deliverables for the respective entities that have been contracted to provide the deliverables. A means for analysis and reviewing of two or more schedules, and tracking various metrics is provided to the owner with means of. Business intelligence information is then automatically generated using the equations, business rules, and the items entered into the program.

### BRIEF DESCRIPTION OF THE DRAWINGS

The foregoing summary, as well as the following detailed description of preferred embodiments of the invention, will be better understood when read in conjunction with the appended drawings. It should be understood, however, that the invention is not limited to the precise arrangements and instrumentalities shown.

FIG. 1: Business Rules and Their Business Description and Formulas, in accordance with embodiments of the present invention.

FIG. 2a: Pareto Analysis Chart for Satisfied Business Rules in the Studied Schedule, in accordance with embodiments of the present invention.

FIG. 2b: List for Satisfied Business Rules allocated to Categories in the Studied Schedule, in accordance with embodiments of the present invention.

FIG. 3: Alerts List's Weighing System, in accordance with embodiments of the present invention.

FIG. 4a: Alerts Screen for the Studied Schedule, in accordance with embodiments of the present invention.

FIG. 4b: Alerts Screen for the Studied Schedule, in accordance with embodiments of the present invention.

FIG. 5: Trend-line Formulas, in accordance with embodiments of the present invention.

FIG. 6: Trend Analysis Screen with Forecasted Data at a Specific Date, in accordance with embodiments of the present invention.

### DETAILED DESCRIPTION OF THE INVENTION

For the purposes of explaining the present invention, specific embodiments will be described. These embodiments are exemplary only, and are not intended to limit the scope of the invention.

### I. Overview

Preferred embodiments of the present invention provide a solution through a computer-implemented method of calculating ranking of activities that are potential causes of schedule issues. In one embodiment, a person who is tasked with reviewing and analyzing a project schedule is provided with a software application program that has equations, business rules, and formulas that together define, track, calculate and report the process, timeline, and deliverables associated with one or more project schedules. In one embodiment, a person will know which activities are the potential cause of the schedule anomalies and they will be ranked based on a composite severity score. This important information protects the original estimates of the project's duration, ensures that anomalies root causes are not being over looked, and creates a means for monitoring and tracking the quality of the schedule throughout the time. Preferred embodiments accept the information, process it through a series of steps, and produce reports that simplify the schedule analysis and approval process and make it more accurate. Various reports can be produced from the derived information, as described below. In one embodiment, activities, relationships, budget, or work-in-process expenses are organized, analyzed, and verified using algorithms that take into account the complexity of schedule and the metric category (e.g., concern, observation). Furthermore, the findings can be communicated and verified by the scheduler, without the need for phone calls, letters, on-site meetings, or other costly and time-consuming methods of communications.

Preferred embodiments provide the owner with reports on the accuracy or inaccuracy of the schedule for a project. This in turn helps owners to make good choices. Equations and business rules work together to define a process, a timeline, and deliverables associated with a schedule review method.

Furthermore, preferred embodiments classify equations and business rules into a number of scoring categories. Equations and business rules are allocated to these categories based on the severity of their anomalousness. The preferred embodiments flags activities that have anomalies using business rule equations that classifies them into the preferred categories. Equations and business rules that do not have any activity flagged with anomalies are filtered out of that category to enhance the focus on the existing anomalies of the timeline schedule.

Any activity can have more than one anomaly with different severity levels. To analyze the project's timeline schedule deeper, activities are ranked based on the level of severity of their anomalousness. Every anomaly has an anomaly severity weight associated with it. The total weight of each activity is used to rank activities in a list.

Moreover, the equations and business rules that are used in analyzing the timeline schedule are used to evaluate the overall performance of the project. For every project, the timeline schedule is usually prepared and updated periodically. The preferred embodiments analyze the results of the equations and business rules over the different periodical updates of the timeline schedule and prepare a trend-line. The trend-line and its prediction limits are developed using regression analysis equations and is used to forecast the performance of the project in the future in terms of the equations and business rules.

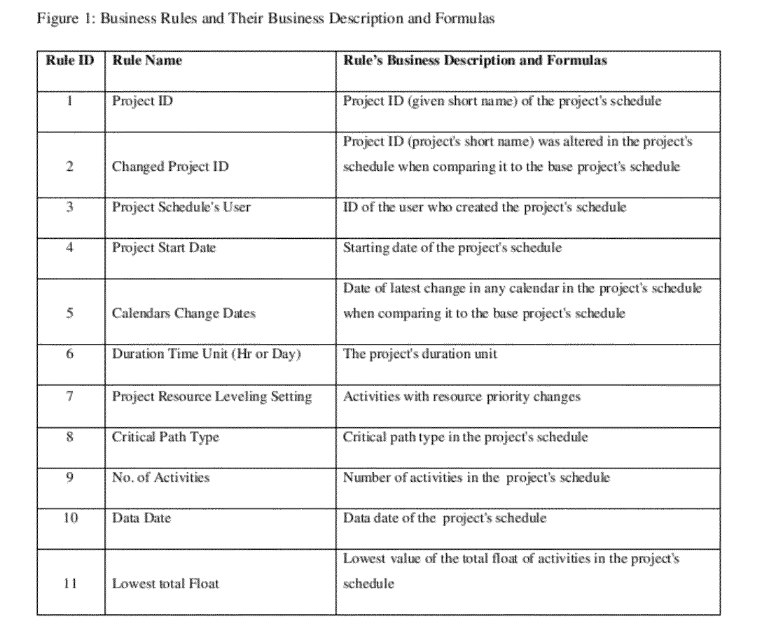

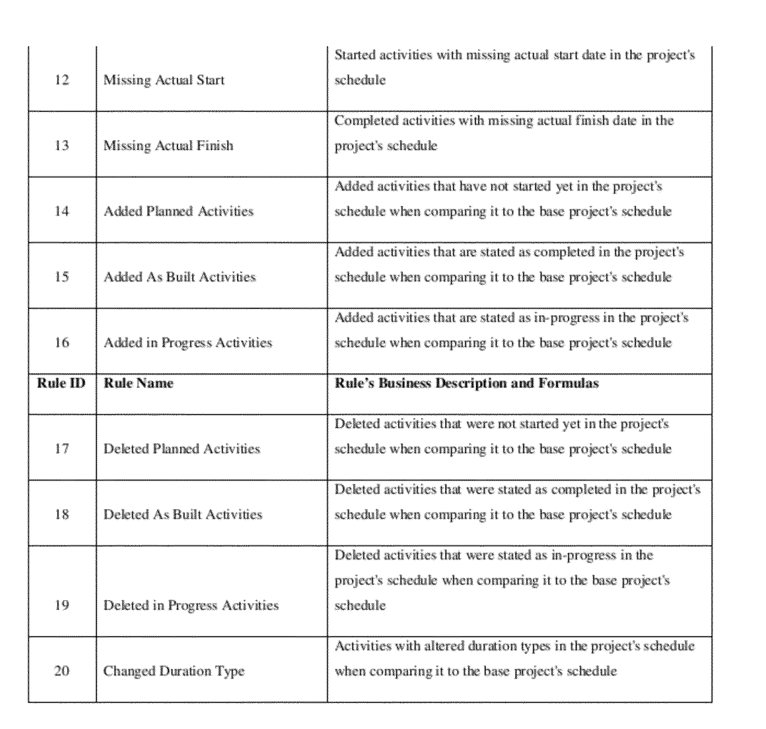

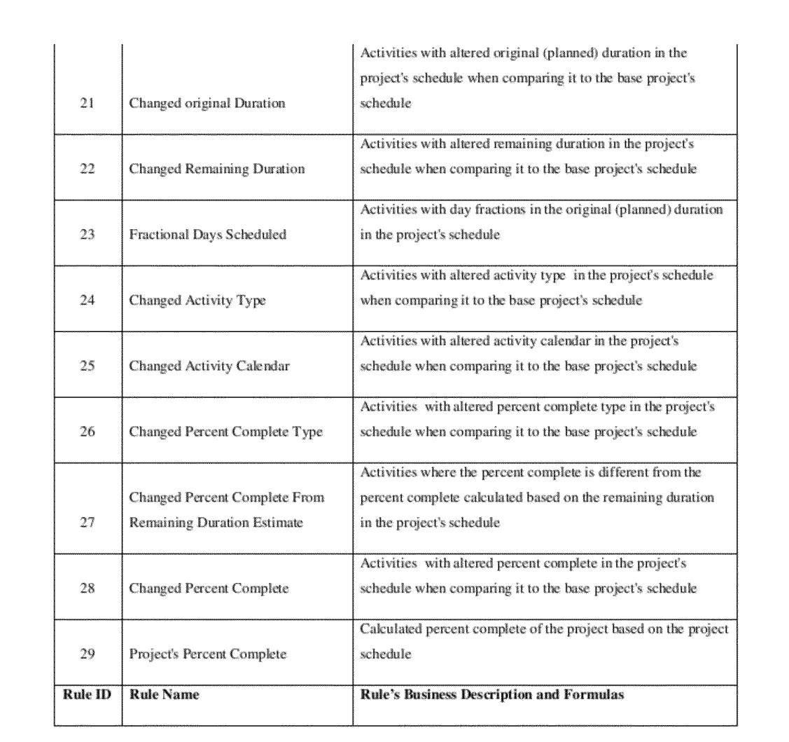

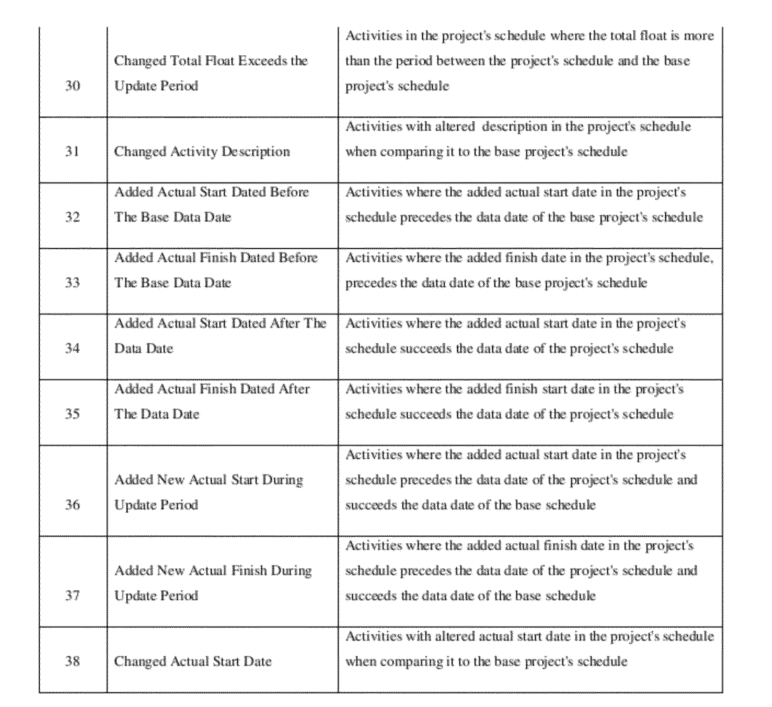

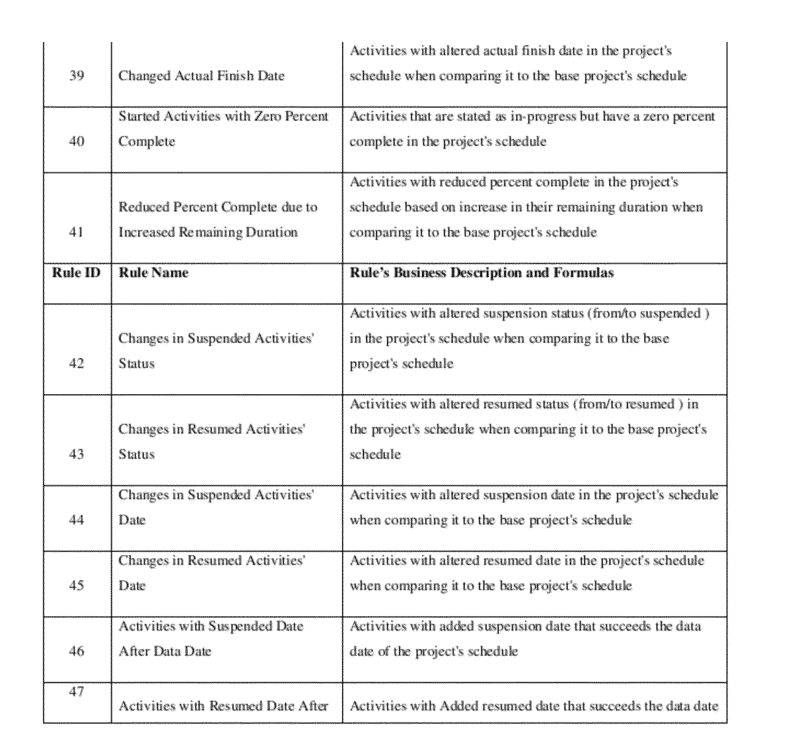

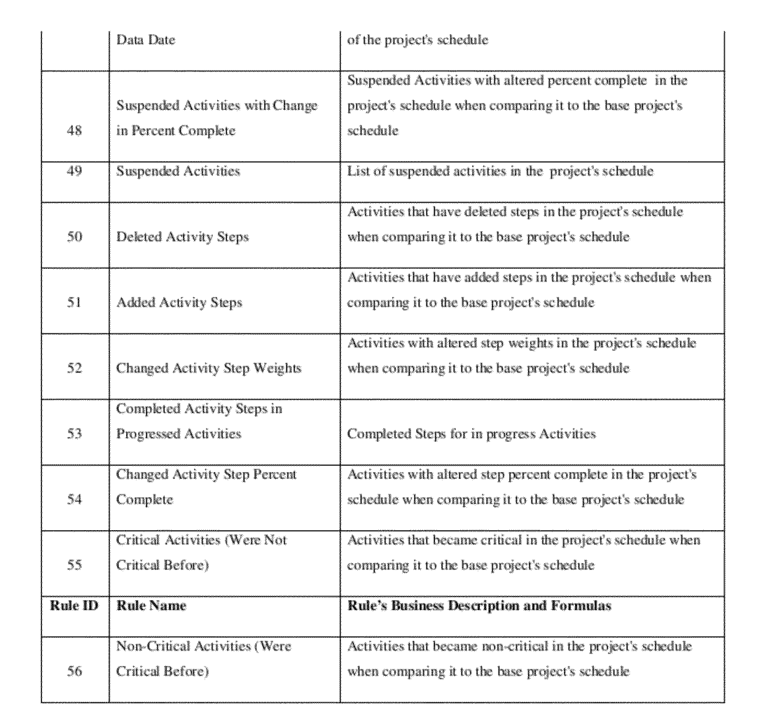

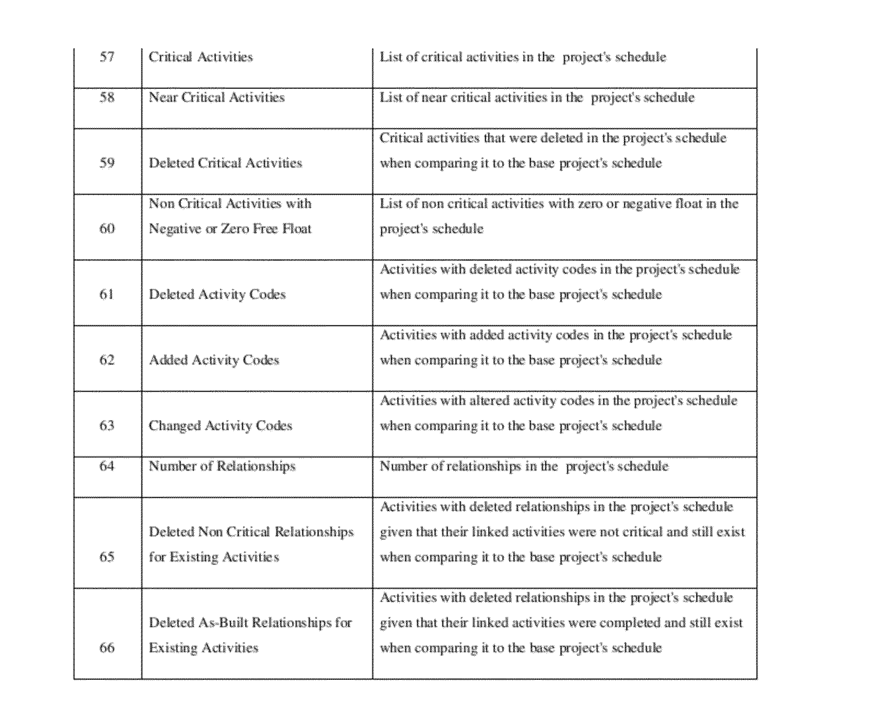

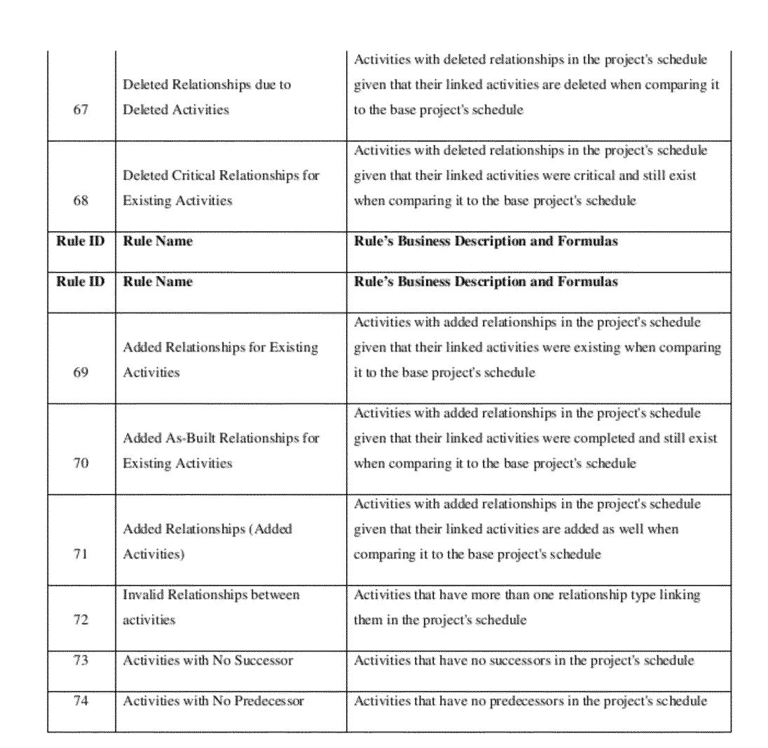

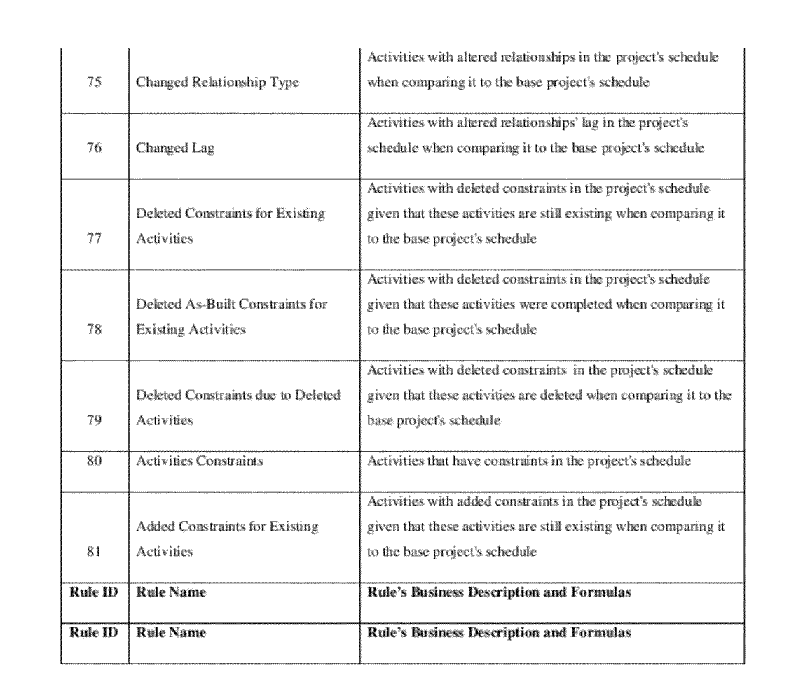

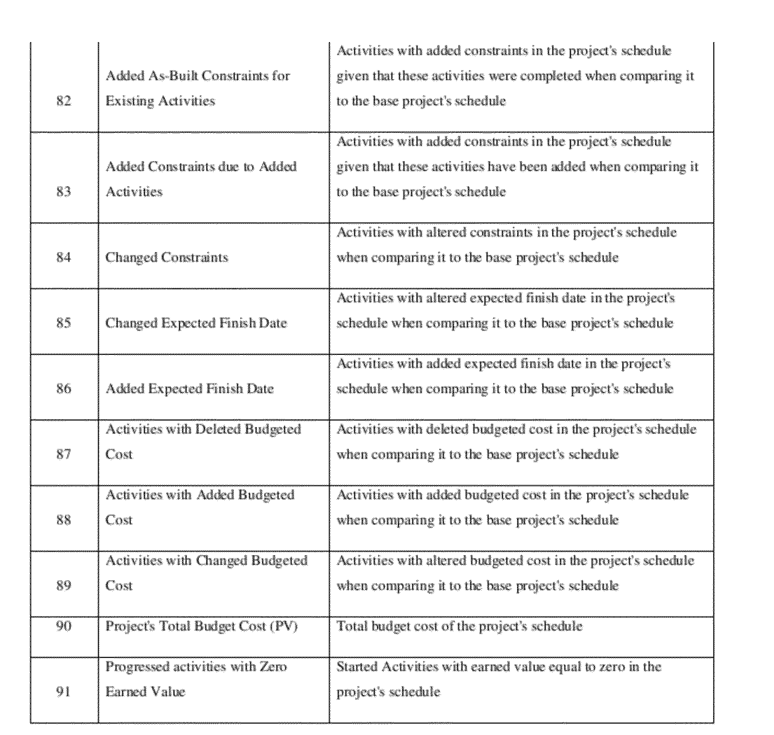

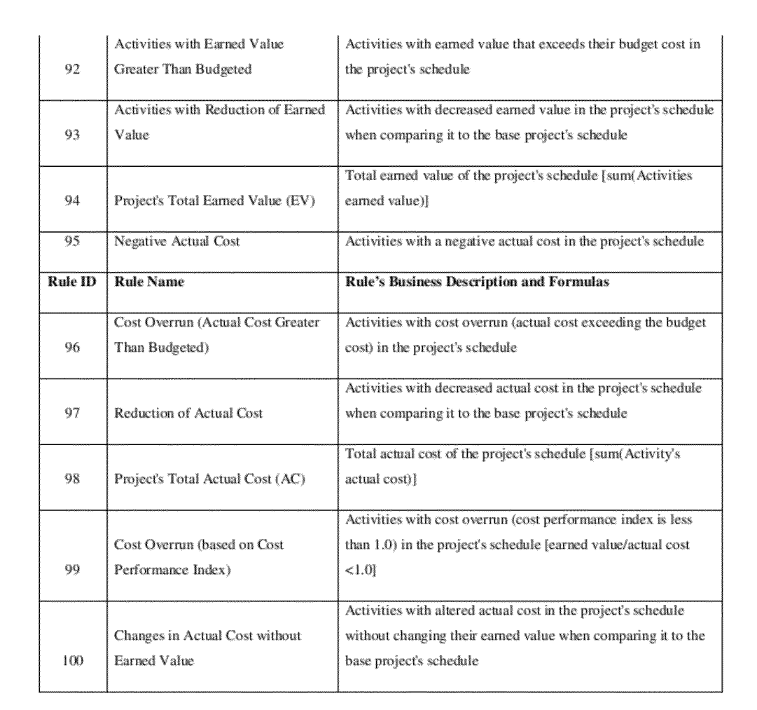

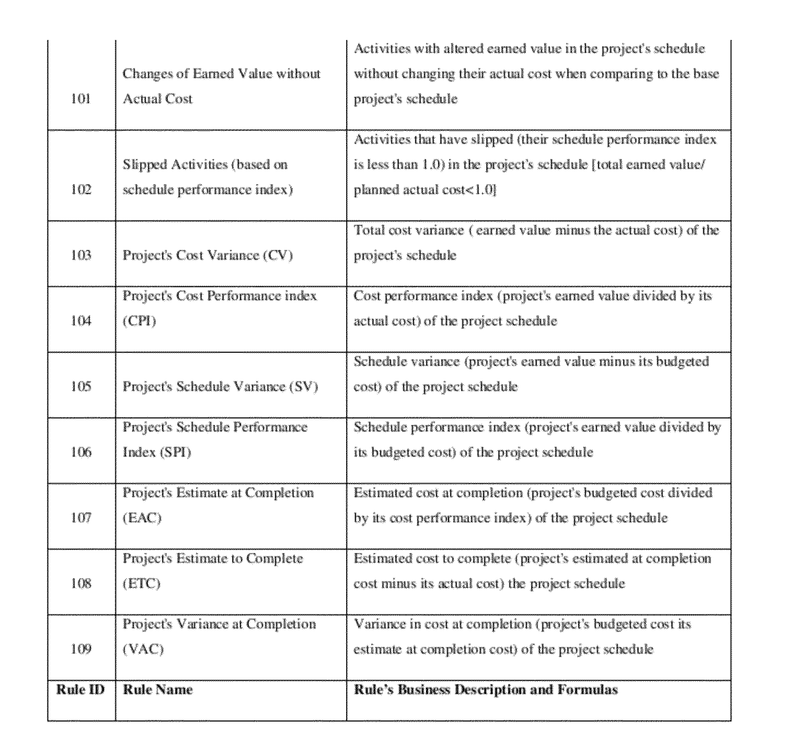

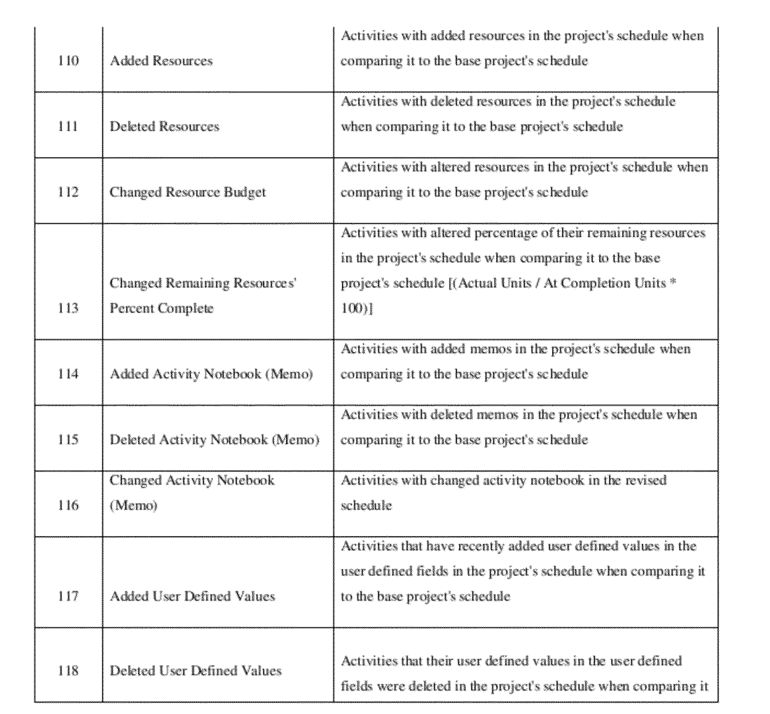

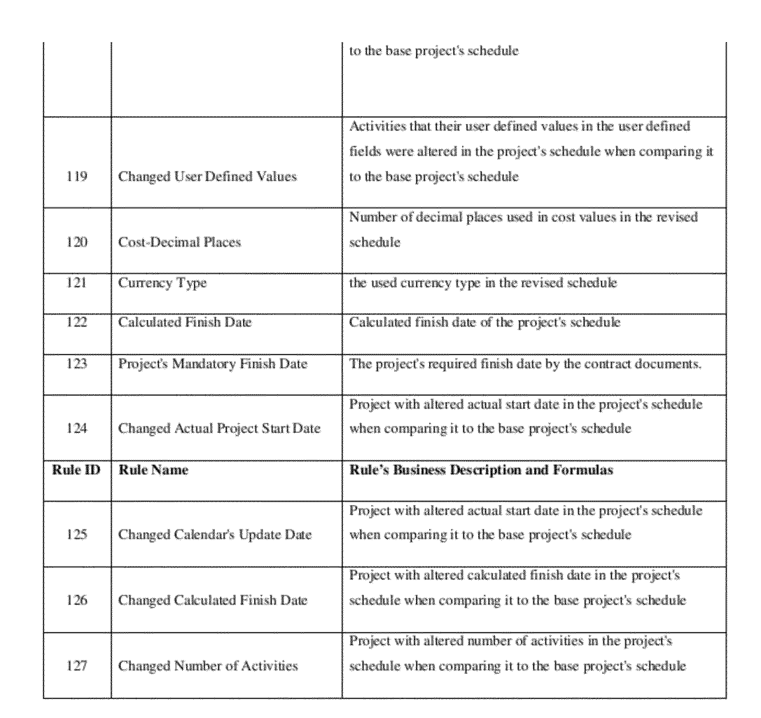

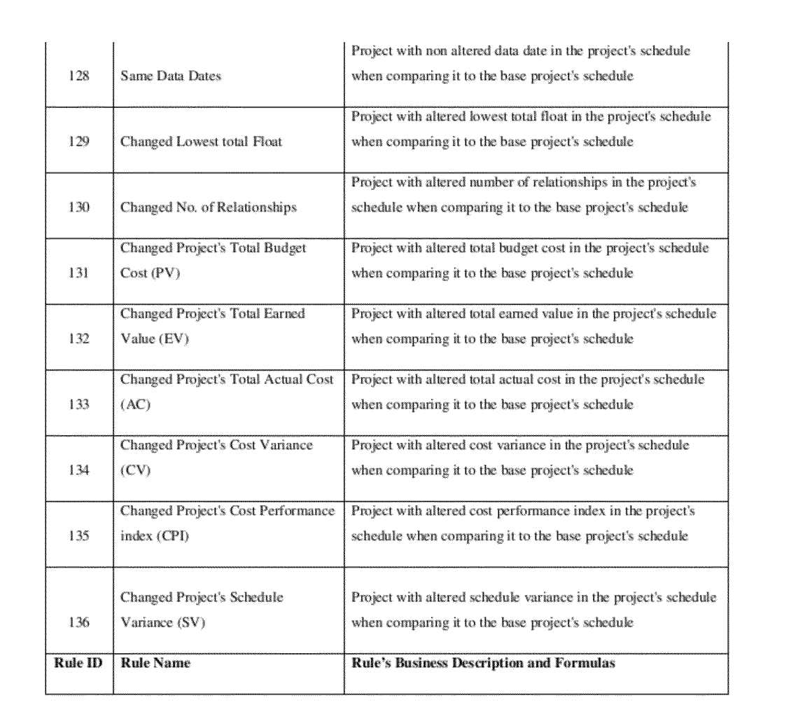

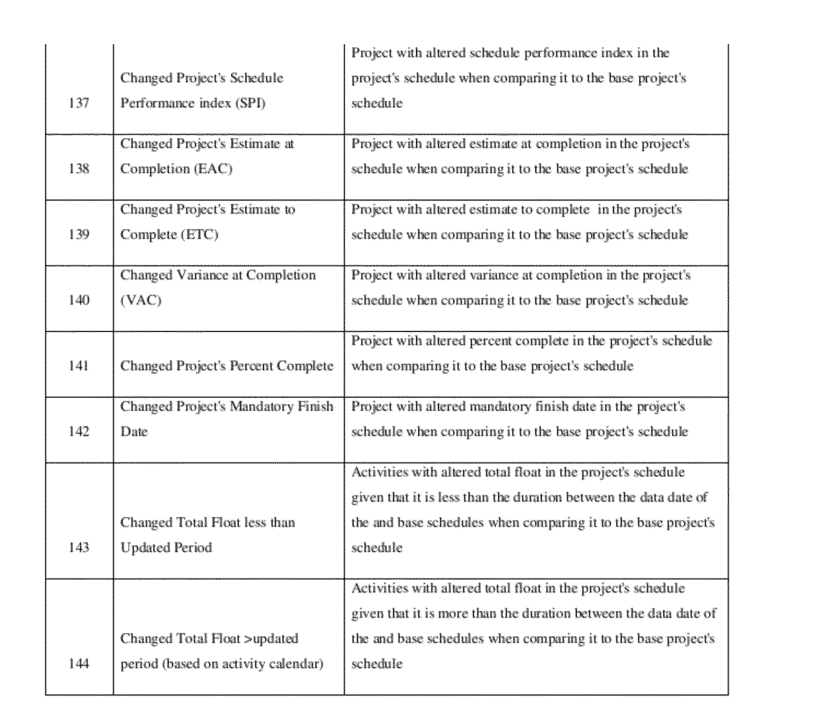

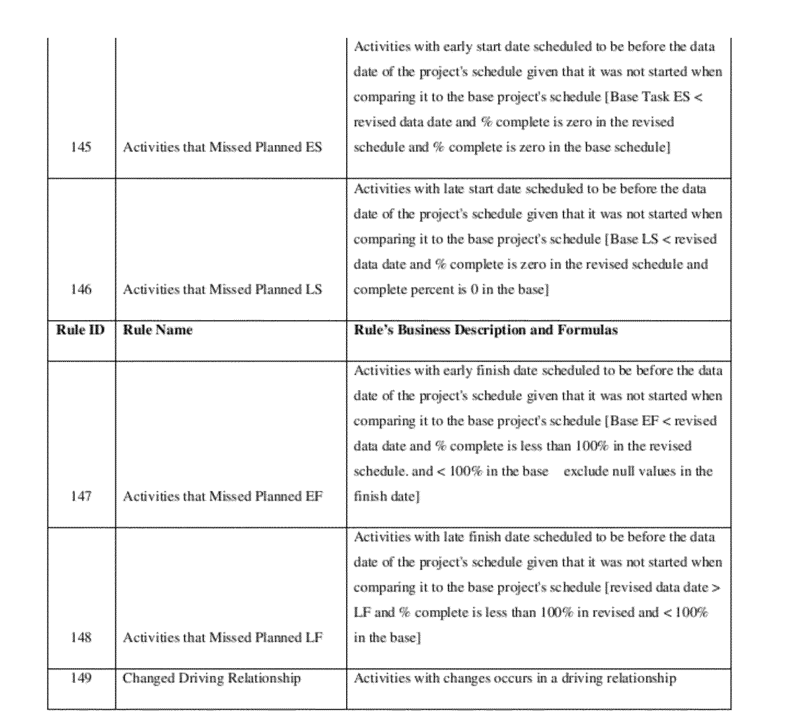

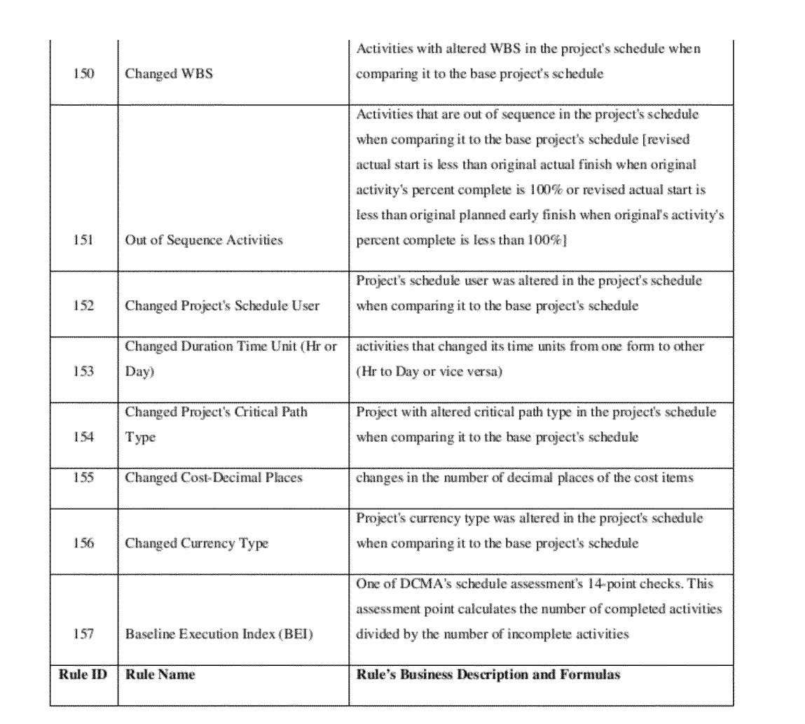

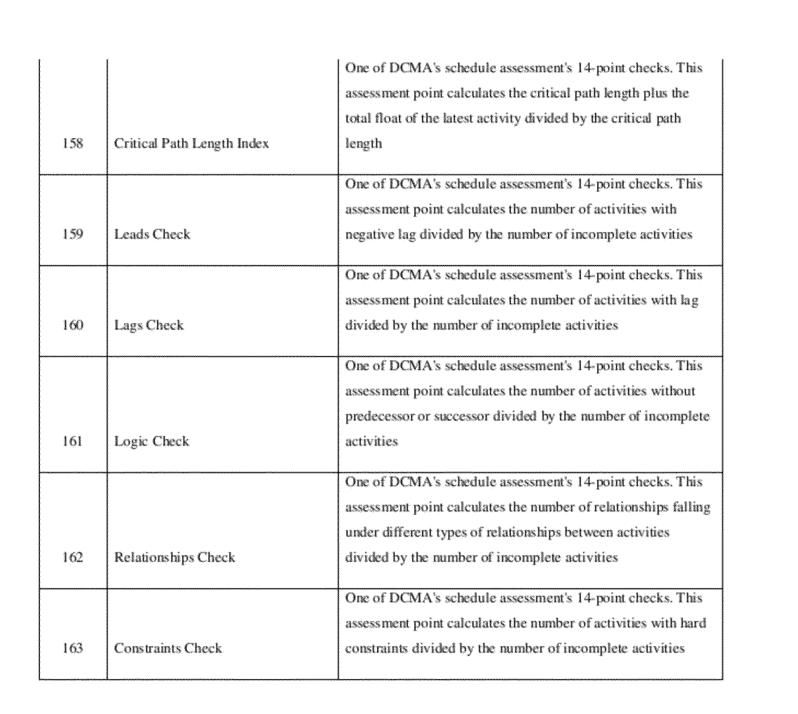

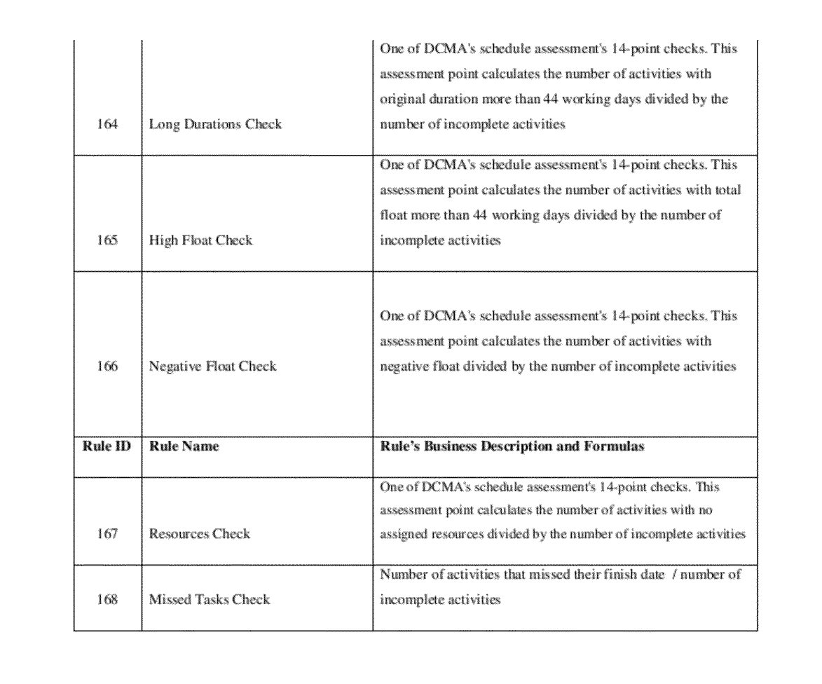

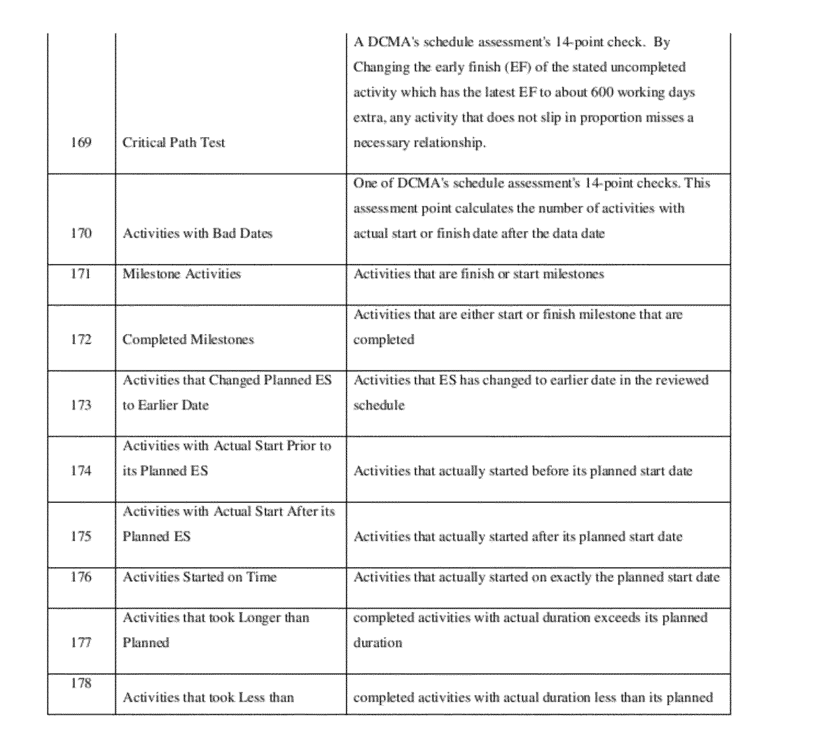

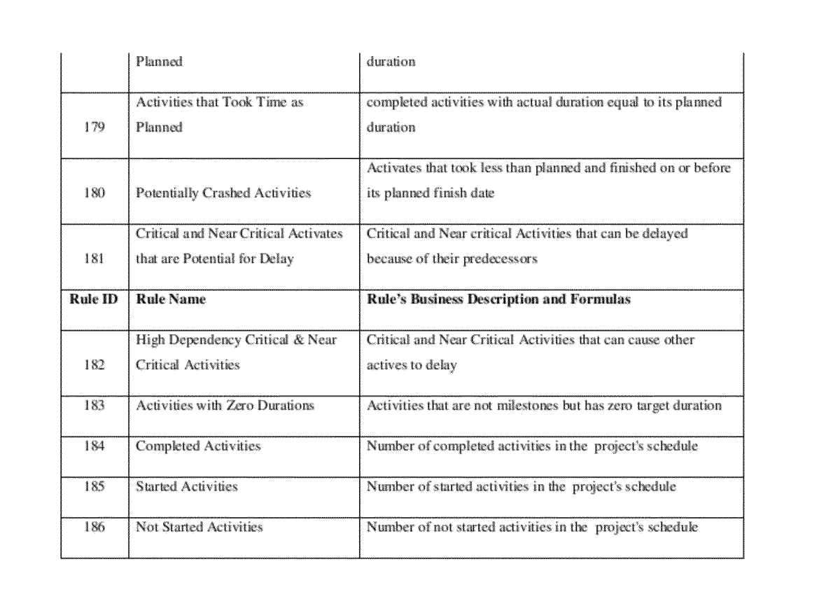

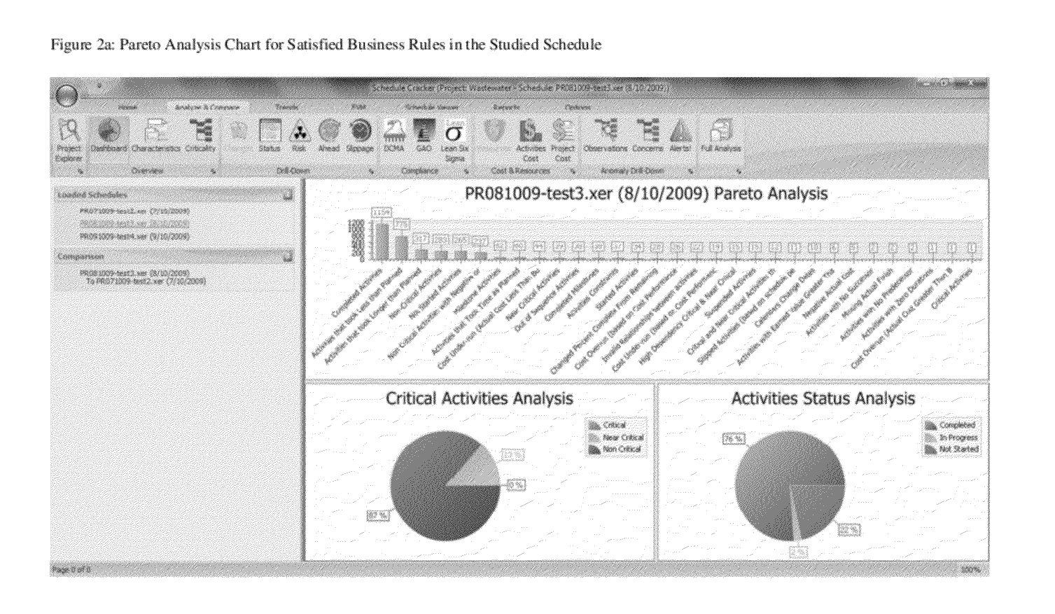

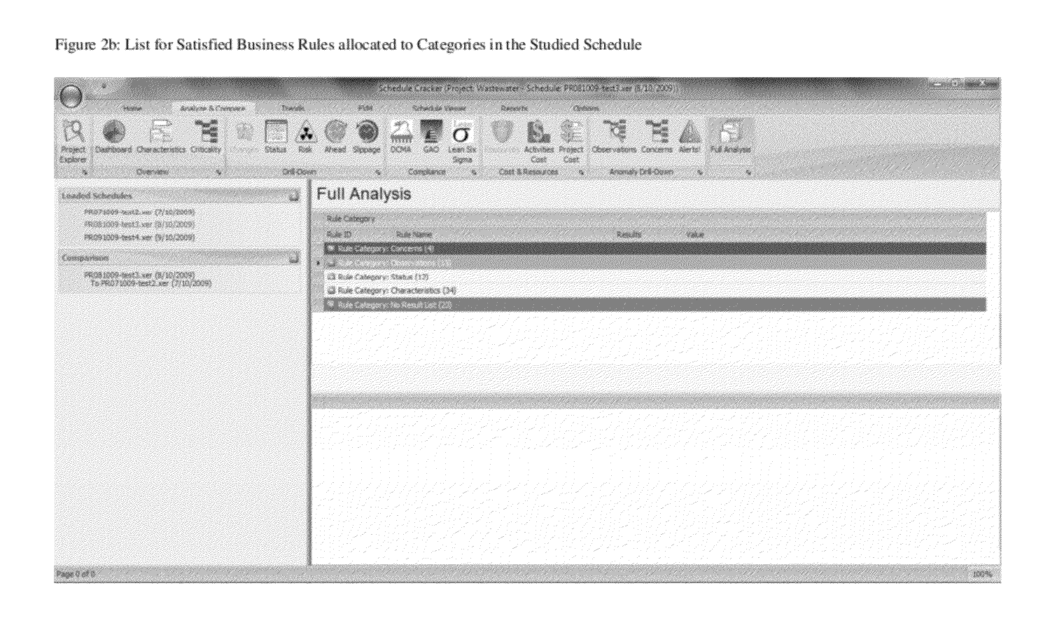

FIGS. 1, 2a and 2b show an apparatus for calculating and identifying anomalies associated with a schedule review method. Broadly stated, the apparatus of FIGS. 1, 2a and 2b operate as follows:

a. A software application program is provided that has equations and business rules that together define a process, a timeline, and deliverables associated with a schedule review method. Some of the equations relate to classifying the activities, relationships, earned value, budget, cost, and the timing thereof, and some of the equations relate to cash inflows and outflows and the timing thereof. The schedule review method has a plurality of phases, and at least some of the business rules relate to the timeline schedule analysis.

b. Timeline schedule of the studied project is imported in the computer program. The timeline schedule can be a baseline and/or periodically update one at a certain time frame. The preferred embodiments allow evaluating the integrity of one timeline schedule or comparison between two schedule updates. For one timeline schedule, the preferred embodiments automatically identify activities that have anomalies in view of the equations and business rules in the program. Moreover, the preferred embodiments fetch facts about the timeline schedule. Anomaly activities, such as those that violate a business rule, cause an “Alert” which would place them in the anomaly metric of the equations or business rules that it violated.

The comparison engine automatically identifies activities that have anomalies or changes during a particular time frame in the timeline schedule. Anomaly or changed activities, such as those that violate a business rule, will trigger an “Alert” which would place them in the anomaly metric of the equations or business rules that it violated.

c. The equations and the business rules are executed on a single timeline schedule to evaluate the integrity of the timeline schedule. Moreover, they are execute to compare the timeline schedule to another one to identify changes in the status, performance, budget, cost, or earned value of the project.

d. The preferred embodiments allocate activities to their respective anomaly metric using equations and business rules. The anomaly metrics are classified under a number of categories based on the severity of the anomalousness. The preferred embodiment automatically removes the anomaly metrics that does not have any activities allocated to them from the anomaly categories to enhance the focus on the real issues.

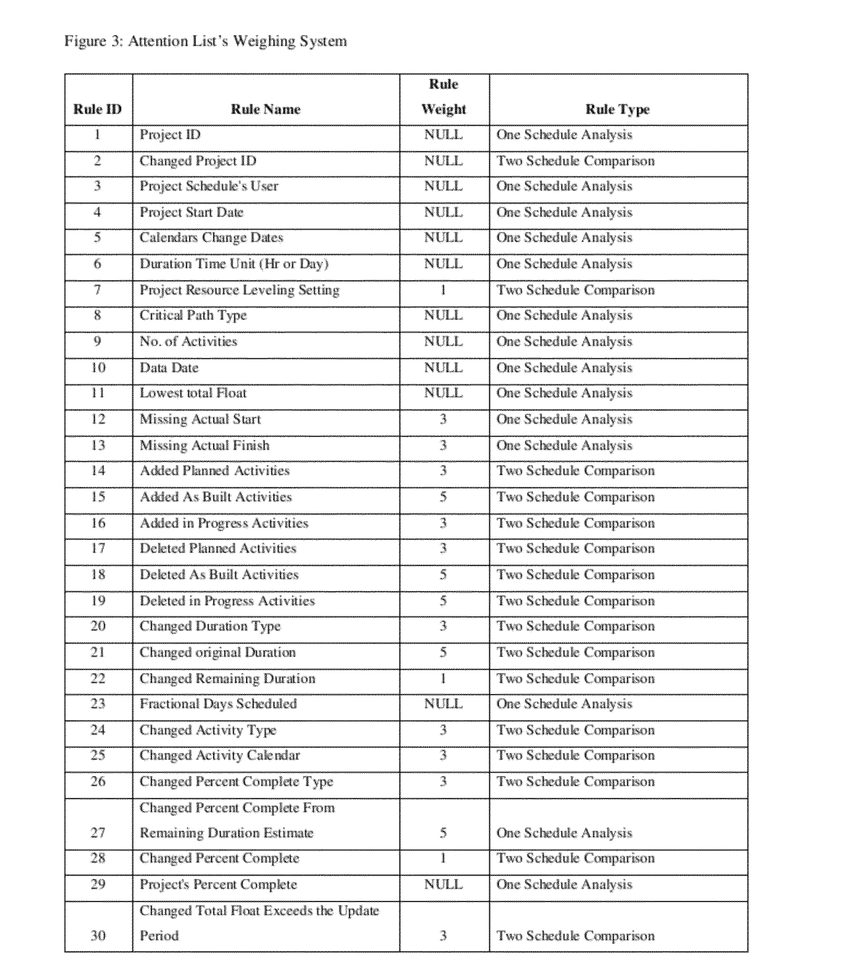

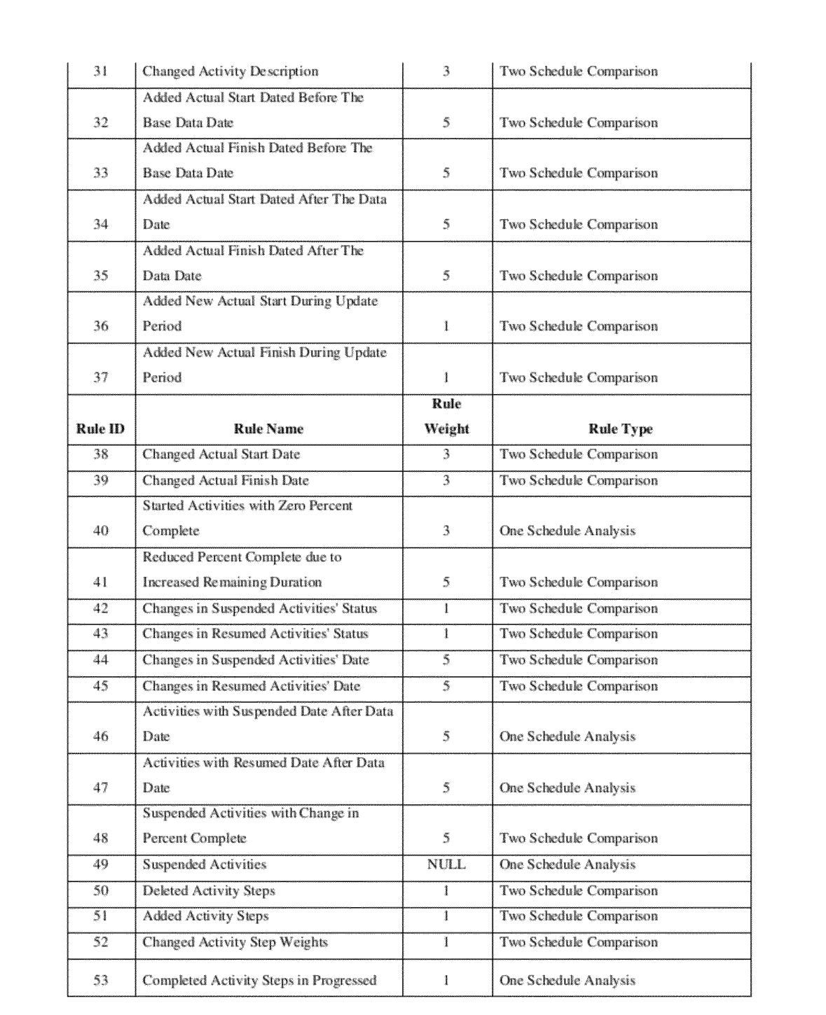

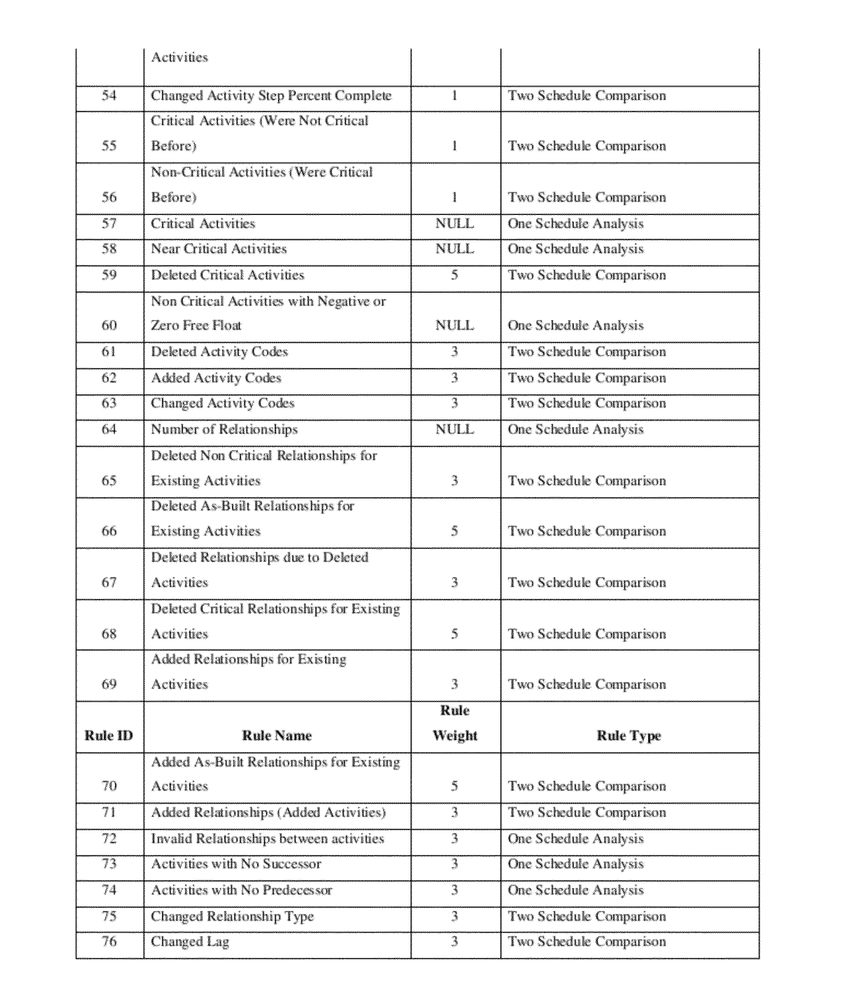

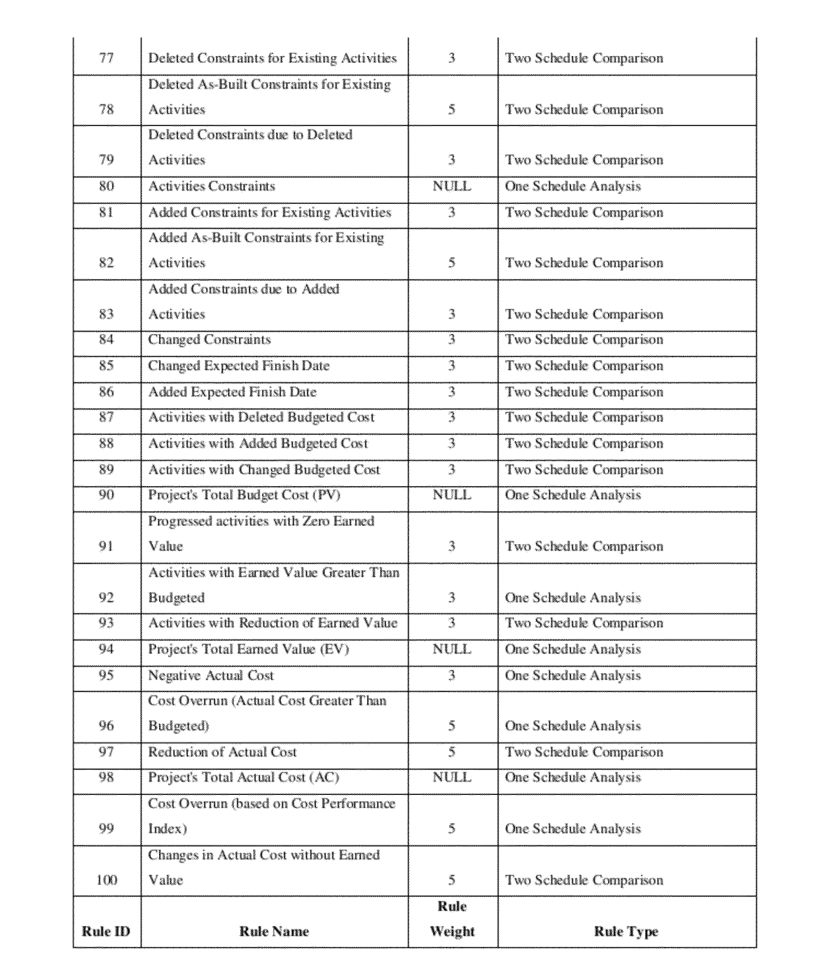

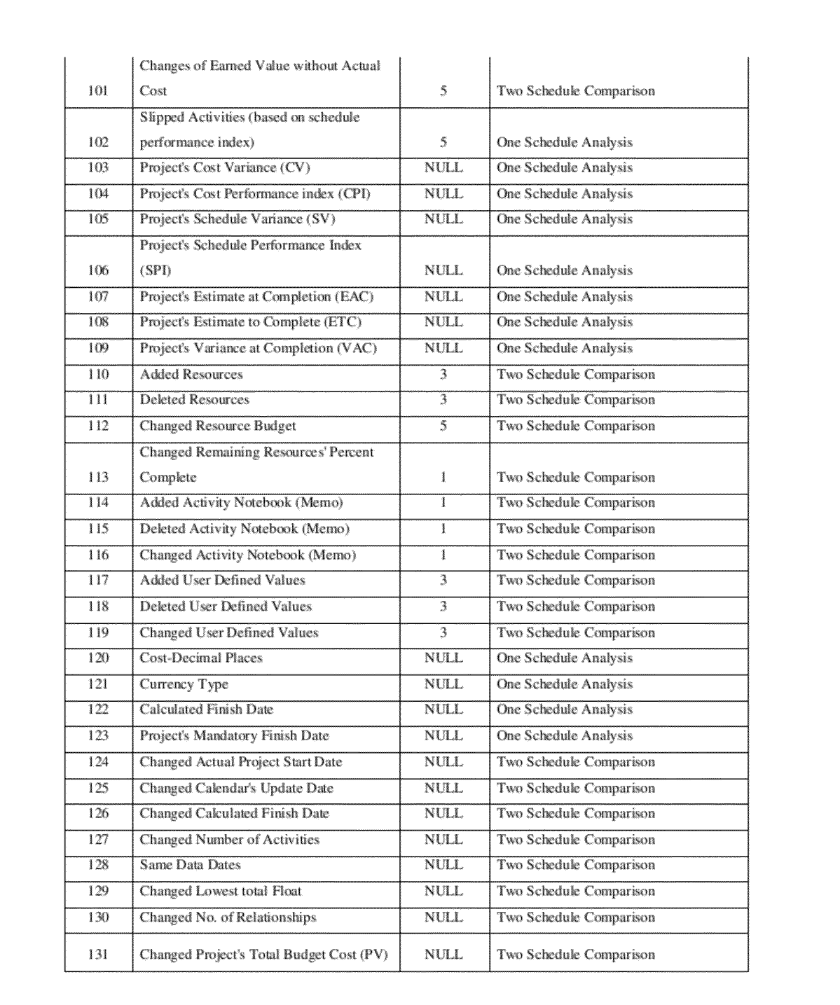

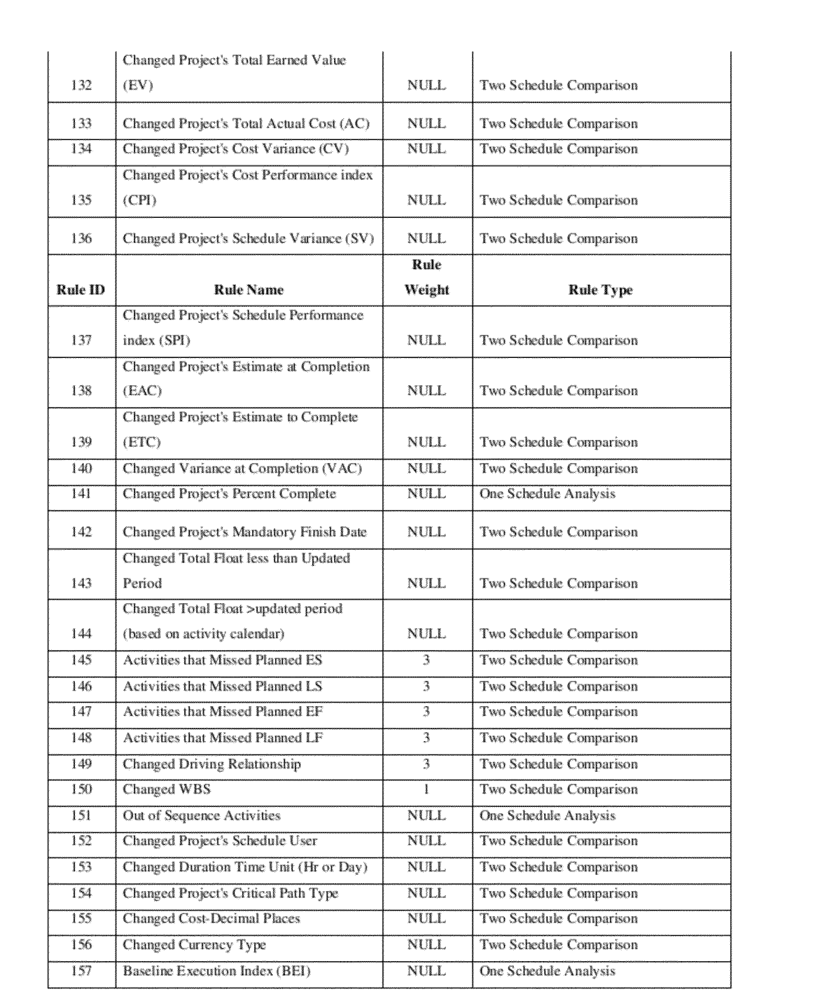

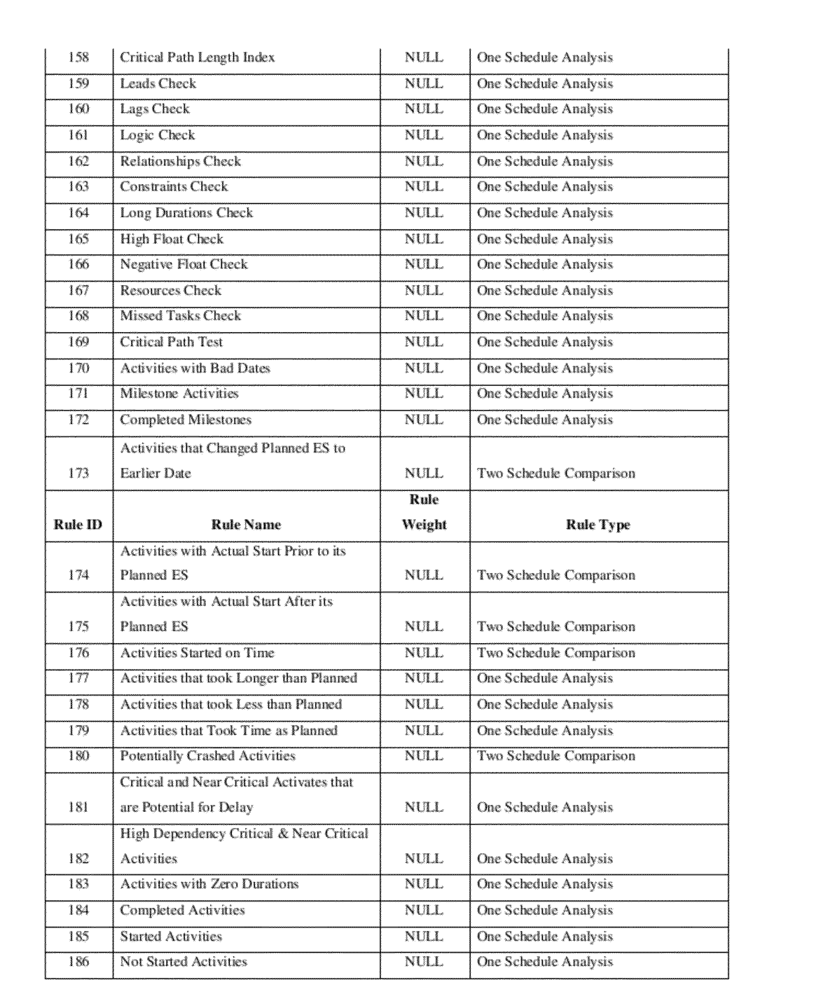

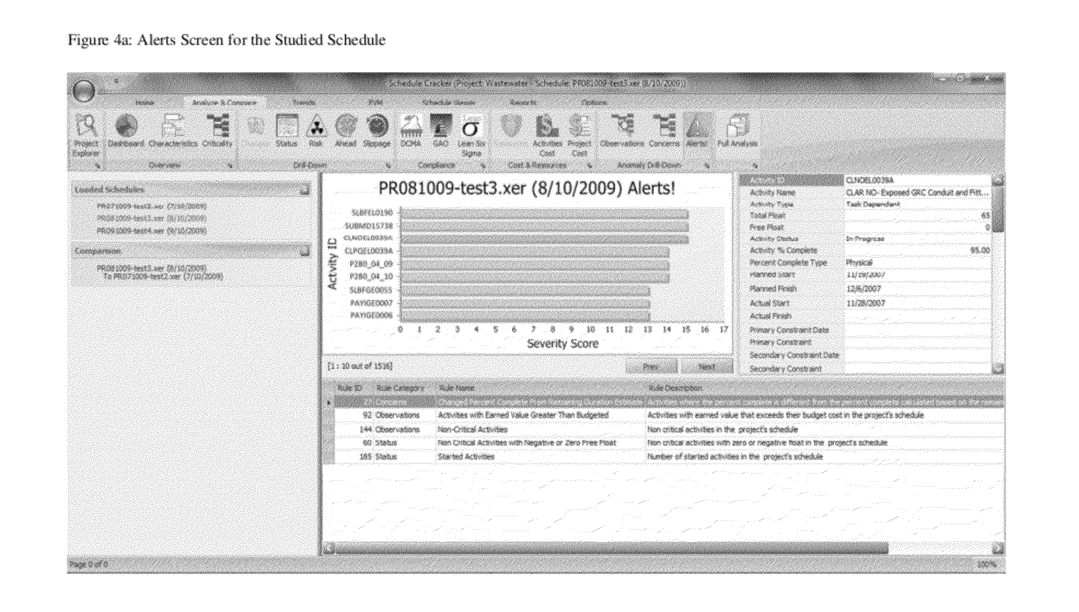

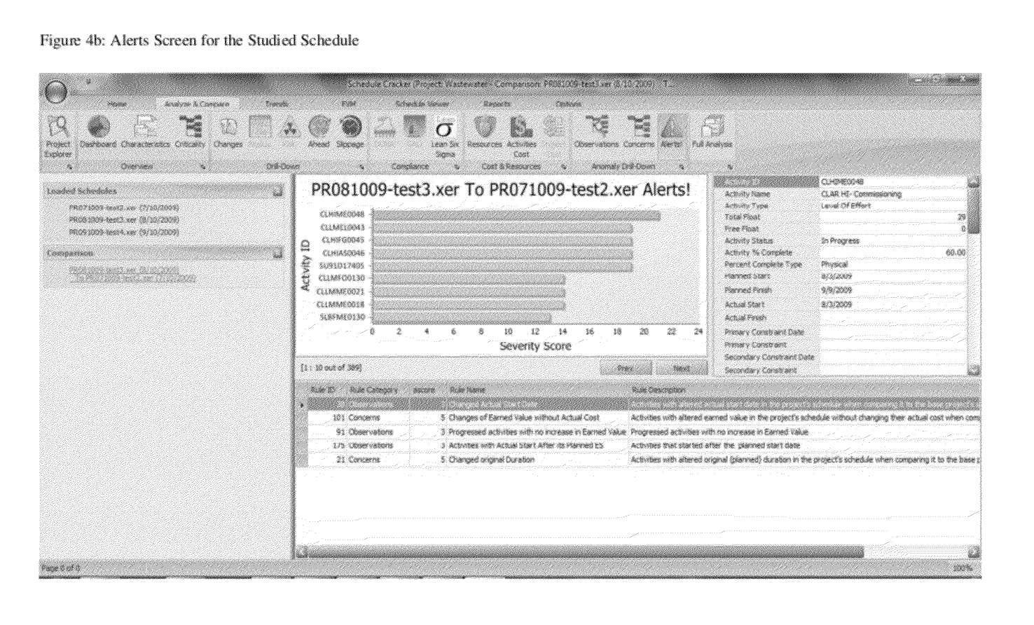

FIGS. 3, 4a and 4b show an apparatus for automatically calculating and ranking activities based on the severity of their anomalousness. Broadly stated, the apparatus of FIGS. 3a, 3b, 4a and 4b operates as follows:

a. Any activity can have more than one anomaly with different severity level. To analyze the project's timeline schedule deeper, activities were ranked based on the level of severity of their anomalousness. Every anomaly has a weight associated with it based on the severity of its anomalousness. A severity score is calculated based on a formula that is shown in FIG. 3b. The severity score of each activity is to rank the activities on the Alerts list.

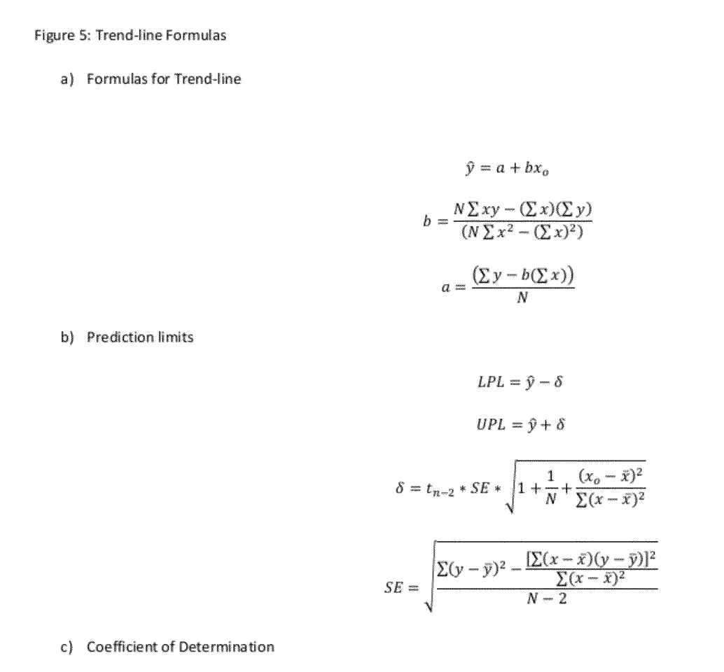

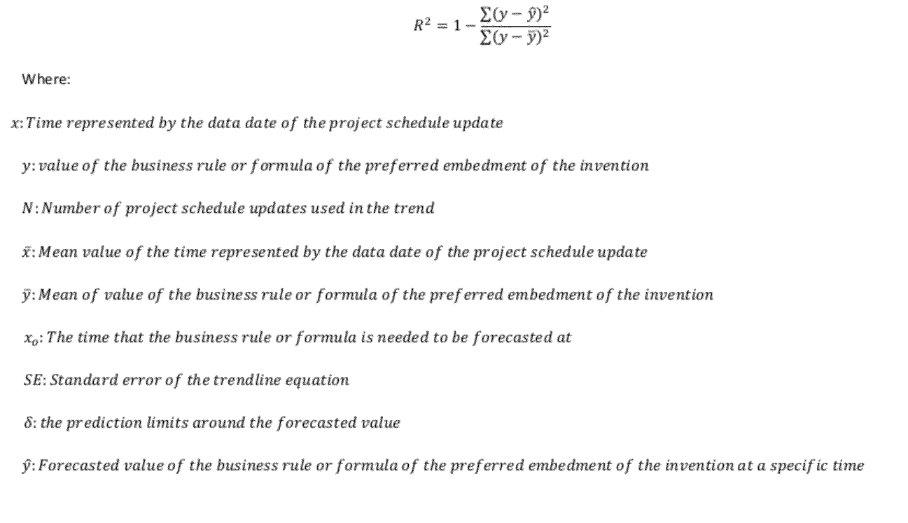

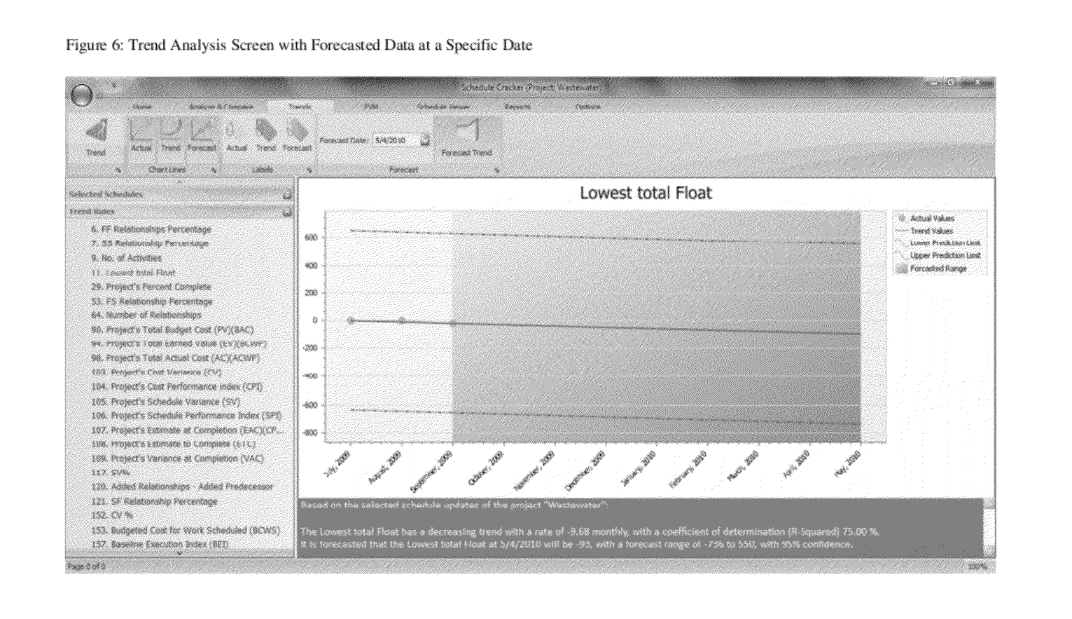

FIGS. 5 and 6 shows equations and an apparatus for automatically generating trend analysis and forecasting of the performance of the project based on equations and business executed on the timeline schedule baseline and/or periodical updates of the project. Broadly stated, the apparatus of FIGS. 5 and 6 operates as follows:

a. The preferred embodiments analyze the results of the equations and business rules over the different periodical updates of the timeline schedule and prepare a trend-line. The trend-line and its prediction limits are developed using regression analysis equations and is used to forecast the performance of the project in the future in terms of the equations and business rules.

b. The preferred embodiments draw the results of the anomaly metrics on different timeline schedules of the project. A trend analysis is performed using the formulas shown in FIG. 5 to identify the performance of the project.

c. Moreover, a forecasting of the performance of the project is performed by extrapolation of the trend-line with prediction limits of the range of forecasting accuracy using formulas shown in FIG. 5.

Any conventional database or spreadsheet program may be used in the software application program shown in FIGS. 1-6. Likewise, the processor and comparison engine shown in FIGS. 1-6 may be part of one or multiple general-purpose computers, such as personal computers (PC) that run a Microsoft Windows® or UNIX® operating system. Furthermore, although the disclosed embodiments manage data using database, the scope of the present invention includes embodiments that use other forms of software that can perform the equivalent function of managing data via spreadsheets.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media is encoded with, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. An automated method of calculating and identifying activities with anomalies associated with a timeline schedule, the method comprising:
(a) Providing a software application program having equations and business rules that together define:
(i) a process associated with the timeline schedule,
(ii) a process of identifying activities with anomalies associated with the timeline schedule,
(ii) a ranking process of activities with anomalies associated with the timeline schedule, and
(iii) deliverables associated with the timeline schedule;
(b) entering into the program: entities that have been contracted to provide the deliverables to the timeline schedule,
(c) automatically identifying using a processor activities with anomalies for the deliverables for the respective entities that have been contracted to provide the deliverables for a specific time frame using in the calculation of the ranked activities with anomalies:
(i) the equations and business rules in the program
(ii) the items entered into the program in step (b).
(iii) a classification mechanism and process
(d) automatically calculating using a processor ranking of activities with anomalies for the deliverables for the respective entities that have been contracted to provide the deliverables for a specific time frame using in the calculation of the ranked activities with anomalies:
(i) the equations and business rules in the program, and
(ii) the items entered into the program in step (b).
(iii) a ranking mechanism and process
(e) wherein the identification and the calculation of ranking of activities with anomalies is performed without entering into the program or otherwise using deliverables from any of the entities.

2. An apparatus for carrying out the method as set forth in claim 1.

3. The method of claim 1 wherein items (b) are obtained from contracts entered into by the entities contracted to provide the deliverables.

4. The method of claim 1 wherein the timeline schedule has a plurality of phases, and at least some plurality of the business rules relate to the deliverables.

5. The method and apparatus of claims 1 and 2 further comprising: comparing activities using a comparison engine received from the entities at a specific time frame with the appropriate activities details and identifying any activity that may not be appropriate and comparison is done for two or more different project's timeline schedules in status using equations and business rules including the equation and business rules for activities with anomalies.

5. A method as set forth in claim 5, further comprising performing trend analysis of the project based on the comparison of equations and business rules for two or more different project's timeline schedules in status including the equation and business rules for activities with anomalies.

6. An apparatus for carrying out the method as set forth in claim 5.
